(19) United States
(12) Patent Application Publication
(10) Pub. No.: US 2004/0174874 A1
(43) Pub. Date: Sep. 9, 2004

(54) AV data transmission and reception scheme for realizing copyright protection

(75) Inventors: Takeshi Saito, Tokyo (JP); Hiroshi Isozaki, Kawasaki-shi (JP); Takashi Kokubo, Oume-shi (JP); Taku Kato, Fuchu-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/782,896

(22) Filed: Feb. 23, 2004

(30) Foreign Application Priority Data
Mar. 5, 2003 (JP) 2003-058927
Jun. 18, 2003 (JP) 2003-173985

(51) Int. Cl. H04L 12/56

(52) U.S. Cl. 370/389

(57) ABSTRACT

An AV stream in which the protocol type and the value of the payload type to be used by this protocol are attached to the payload in which the AV data that requires the copyright protection is encrypted is transmitted from a transmission device to a reception device, so that the reception device that received this AV stream can easily detect that the AV data is encrypted, and easily identify the data for which the authentication and key exchange is necessary, and it becomes possible to receive and reproduce the AV data easily and quickly, while realizing the copyright protection.

### BACKGROUND OF THE INVENTION

1. Field of the Invention

The present invention relates to a transmission device, a reception device, a transmission control program and a reception control program for transmitting or receiving electronic data that require the copyright protection.

2. Description of the Related Art

The products called digital information home electronics are proliferating. These products are expected to become more widespread in conjunction with the start of the digital broadcasting, and include wide range of products for handling digital data and digital contents such as digital broadcasting compatible TV, set-top box, digital VTR, DVD player, hard disk recorder, etc.

For these products, there is a need to account for the copyright protection. The digital data has an advantage that the quality of the digital data will not be degraded even when they are copied but the digital data also has an disadvantage that the illegal copy can be made easily. For this reason, in the IEEE 1394 which is a digital network for connecting digital AV devices, the authentication and key exchange mechanism and the data encryption function are provided (see documents disclosed at “http://www.dtcp.com” for details).

Now, in recent years, in addition to the IEEE 1394, it becomes possible to easily construct networks (Ethernet, radio LAN, etc.) using PCs at home. This is due to the spread of PCs, the lowered cost of the broadband environment, the spread of devices and software compatible with the networks, etc. There is a possibility for the AV devices to join this trend.

The protocol utilized in such an environment is mainly the IP (Internet Protocol).

However, the IP itself does not specifically account for the copyright protection, so that there is a possibility for becoming unable to provide the sufficient copyright protection to the AV data. In particular, in the recently appeared circumstance in which the radio networks such as radio LAN and Bluetooth are widespread, a possibility by which the AV data that require the copyright protection are copied or reproduced without permission becomes high.

### BRIEF SUMMARY OF THE INVENTION

It is therefore an object of the present invention to provide a transmission device, a reception device, a transmission control program and a reception control program capable of carrying out transmission or reception of the AV data while realizing the copyright protection.

According to one aspect of the present invention there is provided a transmission device, comprising: a transmission control unit configured to control a transmission of a packet that requires a copyright protection which contains an encrypted electronic data, a copyright protection control data, and an RTP (Real-time Transport Protocol) header including a value of a dynamic payload type that indicates information regarding a state of the encrypted electronic data; a negotiation unit configured to carry out a negotiation to determine the value of the dynamic payload type for each communication in advance, with a reception device; and an authentication and key exchange processing unit configured to carry out an authentication and key exchange processing for purpose of the copyright protection, with the reception device.

According to another aspect of the present invention there is provided a reception device, comprising: a reception control unit configured to control a reception of a packet containing an encrypted electronic data, a copyright protection control data, and an RTP (Real-time Transport Protocol) header including a value of a dynamic payload type that indicates information regarding a state of the encrypted electronic data; a negotiation unit configured to carry out a negotiation to determine the value of the dynamic payload type for each communication in advance, with a transmission device; and an authentication and key exchange processing unit configured to carry out an authentication and key exchange processing for purpose of a copyright protection, with the transmission device.

According to another aspect of the present invention there is provided a computer program product for causing a computer to function as a transmission device, the computer program product comprising: a first computer program code for causing the computer to control a transmission of a packet that requires a copyright protection which contains an encrypted electronic data, a copyright protection control data, and an RTP (Real-time Transport Protocol) header including a value of a dynamic payload type that indicates information regarding a state of the encrypted electronic data; a second computer program code for causing the computer to carry out a negotiation to determine the value of the dynamic payload type for each communication in advance, with a reception device; and a third computer program code for causing the computer to carry out an authentication and key exchange processing for purpose of the copyright protection, with the reception device.

According to another aspect of the present invention there is provided a computer program product for causing a computer to function as a reception device, the computer program product comprising: a first computer program code for causing the computer to control a reception of a packet containing an encrypted electronic data, a copyright protection control data, and an RTP (Real-time Transport Protocol) header including a value of a dynamic payload type that indicates information regarding a state of the encrypted electronic data; a second computer program code for causing the computer to carry out a negotiation to determine the value of the dynamic payload type for each communication in advance, with a transmission device; and a third computer program code for causing the computer to carry out an authentication and key exchange processing for purpose of a copyright protection, with the transmission device.

Other features and advantages of the present invention will become apparent from the following description taken in conjunction with the accompanying drawings.

### BRIEF DESCRIPTION OF THE DRAWINGS

FIG. 1 is a block diagram showing a schematic configuration of an AV communication system having a transmission device and a reception device according to one embodiment of the present invention.

FIG. 2 is a block diagram showing one exemplary internal configuration of a transmission device according to the first embodiment of the present invention.

FIG. 3 is a block diagram showing one exemplary internal configuration of a reception device according to the first embodiment of the present invention.

FIG. 4 is a diagram showing a data format of data to be exchanged between the transmission device and the reception device according to the first embodiment of the present invention.

FIG. 5 is a diagram showing one exemplary further detailed data format of a payload portion of data to be exchanged between the transmission device and the reception device according to the first embodiment of the present invention.

FIG. 6 is a sequence chart showing one exemplary processing procedure of an AV data encryption and transmission processing to be carried out by the transmission device and the reception device of the first embodiment of the present invention.

FIG. 7 is a diagram showing another exemplary further detailed data format of a payload portion of data to be exchanged between the transmission device and the reception device according to the first embodiment of the present invention.

FIG. 8 is a sequence chart showing an exemplary processing procedure for processing Ka, Kb and Kz according to the first embodiment of the present invention.

FIG. 9 is a sequence chart showing an exemplary processing procedure for detecting a contents key update by the transmission device according to the first embodiment of the present invention.

FIG. 10 is a sequence chart showing an exemplary processing procedure when a lower one bit of a seed value is used according to the first embodiment of the present invention.

FIG. 11 is a sequence chart showing an exemplary processing procedure when a packet loss occurs while a lower one bit of a seed value is used according to the first embodiment of the present invention.

FIG. 12 is a sequence chart showing an exemplary processing procedure when lower plural bits of a seed value are used according to the first embodiment of the present invention.

FIG. 13 is a block diagram showing another exemplary internal configuration of a reception device according to the first embodiment of the present invention when lower plural bits of a seed value are used.

FIG. 14 is a sequence chart showing one exemplary processing procedure of an AV data encryption and transmission processing to be carried out by the transmission device and the reception device of the second embodiment of the present invention.

FIG. 15 is a sequence chart showing another exemplary processing procedure of an AV data encryption and transmission processing to be carried out by the transmission device and the reception device of the second embodiment of the present invention.

FIG. 16 is a sequence chart showing one exemplary processing procedure of an AV data encryption and transmission processing to be carried out by the transmission device and the reception device of the third embodiment of the present invention.

FIG. 17 is a sequence chart showing another exemplary processing procedure of an AV data encryption and transmission processing to be carried out by the transmission device and the reception device of the fourth embodiment of the present invention.

FIG. 18 is a block diagram showing one exemplary internal configuration of a reception device according to the fourth embodiment of the present invention.

FIG. 19 is a block diagram showing another exemplary internal configuration of a reception device according to the fourth embodiment of the present invention.

FIG. 20 is a block diagram showing one exemplary internal configuration of a transmission device according to the fourth embodiment of the present invention.

FIG. 21 is a sequence chart showing one exemplary processing procedure of an AV data encryption and transmission processing to be carried out by the transmission device and the reception device of the fourth embodiment of the present invention.

FIG. 22 is a block diagram showing another exemplary internal configuration of a reception device according to the fourth embodiment of the present invention.

FIG. 23 is a block diagram showing one exemplary internal configuration of a transmission device according to the fourth embodiment of the present invention.

FIG. 24 is a sequence chart showing another exemplary processing procedure of an AV data encryption and transmission processing to be carried out by the transmission device and the reception device of the fourth embodiment of the present invention.

FIG. 25 is a block diagram showing another exemplary internal configuration of a reception device according to the fourth embodiment of the present invention.

FIG. 26 is a block diagram showing one exemplary internal configuration of a transmission device according to the fourth embodiment of the present invention.

FIG. 27 is a diagram showing a data format of a size specification request packet that can be used in the fourth embodiment of the present invention.

FIG. 28 is a diagram showing a data format of a size specification response packet that can be used in the fourth embodiment of the present invention.

### DETAILED DESCRIPTION OF THE INVENTION

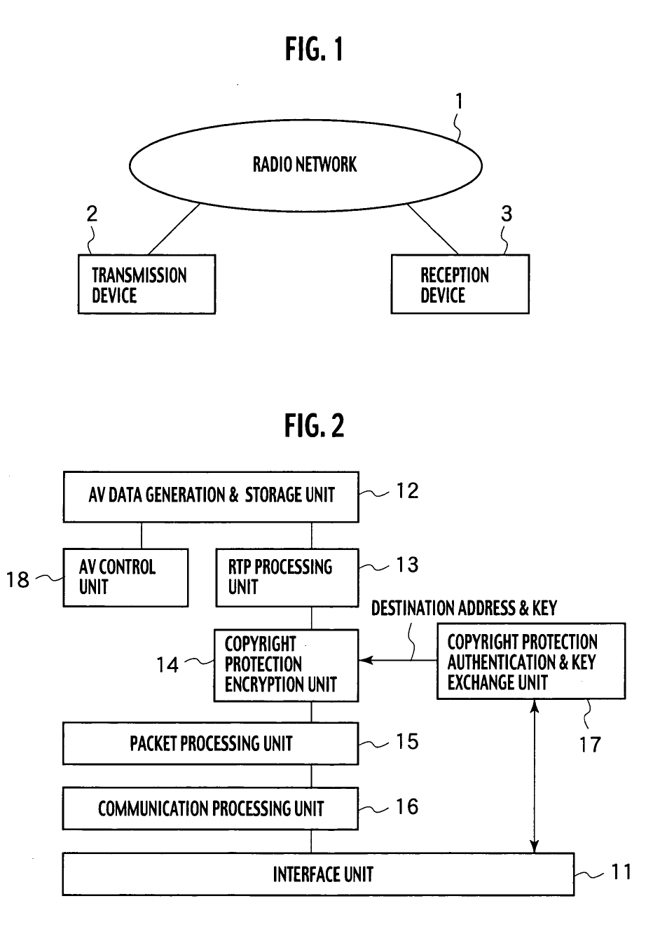

Referring now to FIG. 1 to FIG. 28, embodiments of the transmission device, the reception device, the transmission control program and the reception control program according to the present invention will be described in detail.

In the following an exemplary case of transmitting and receiving AV data such as sound data or video data, but the present invention is also applicable to various types of electronic data other than the AV data.

(First Embodiment)

FIG. 1 shows a schematic configuration of an AV communication system having the transmission device and the reception device according to one embodiment of the present invention. The AV communication system of FIG. 1 comprises a home network 1 at some home, and the transmission device 2 and the reception device 3 that are connected to this home network 1. In the following, an exemplary case where the home network 1 is a radio network 1 will be described, but it is also possible to use a wire network such as Ethernet or IEEE 1394 in parallel to or instead of the radio network 1. The specific form of the radio network 1 is not essential but it is possible to use various types of radio LAN such as IEEE 802.11a, IEEE 802.11b, IEEE 802.11g, etc., for example.

The transmission device 2 and the reception device 3 carry out exchanges of the AV data. The transmission device 2 is a device that can be a transmission device of the AV data such as a set-top box, DVD player, etc. The reception device 3 is a device that can be a reception device of the AV data such as a TV, display device, speaker, AV recording device, etc.

FIG. 2 shows an exemplary internal configuration of the transmission device 2. The transmission device 2 of FIG. 2 has an interface unit 11, an AV data generation and storage unit 12, an RTP (Real-time Transport Protocol) processing unit 13, a copyright protection encryption unit 14, a packet processing unit 15, a communication processing unit 16, a copyright protection authentication and key exchange unit 17, and an AV control unit 18.

The interface unit 11 is a unit to be connected to the radio network 1, which transmits the AV data, etc., to the radio network 1. The AV data generation and storage unit 12 generates or stores the AV data to be transmitted to the reception device 3. The RTP processing unit 13 carries out the processing of the transport layer such as a timestamp processing, a sequence number processing, etc., and an AV control such as play, stop, etc. The communication processing unit 16 generates and transmits frames of the datalink layer that contain the AV data (in the following, Ethernet frames will be used as an example of frames of the datalink layer), and receives the Ethernet frames received through the radio network 1. The copyright protection authentication and key exchange unit 17 carries out the authentication and the key exchange processing with the reception device 3, for the purpose of the copyright protection.

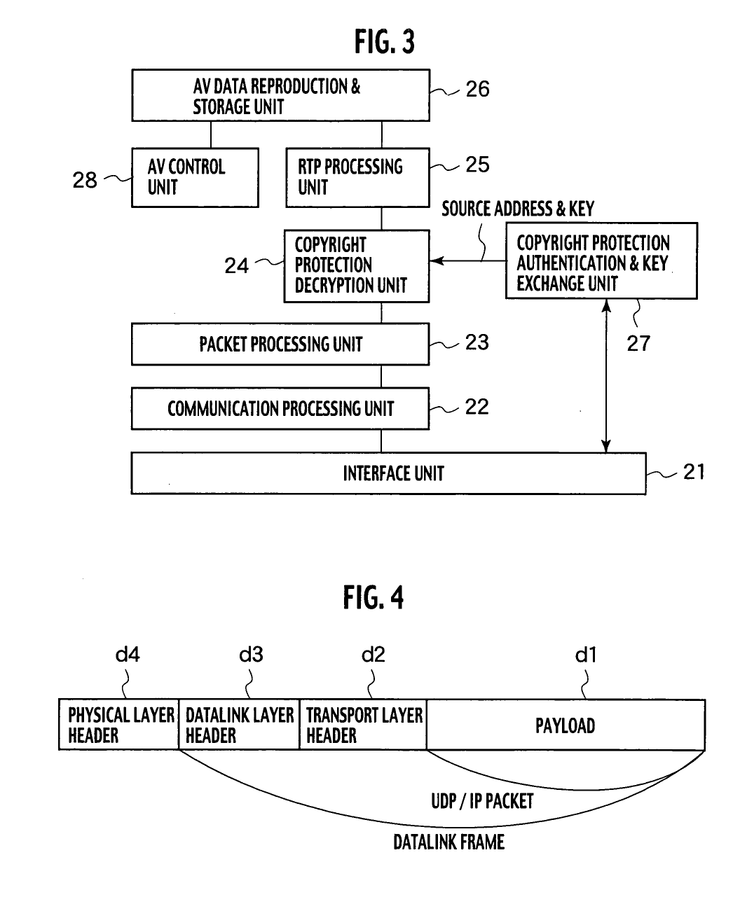

FIG. 3 shows an exemplary internal configuration of the reception device 3. The reception device 3 of FIG. 3 has an interface unit 21, a communication control unit 22, a packet processing unit 23, a copyright protection decryption unit 24, an RTP processing unit 25, an AV data reproduction and storage unit 26, a copyright protection authentication and key exchange unit 27, and an AV control unit 28.

The communication processing unit 22 extracts frames of the datalink layer (Ethernet frames in this example) from the packets received at the interface unit 21. The packet processing unit 23 extracts UDP/IP packets or TCP/IP packets from the Ethernet frames received by the communication processing unit 22. The copyright protection decryption unit 24 decrypts the AV data transferred in an encrypted form for the purpose of the copyright protection. The RTP processing unit 25 and the copyright protection authentication and key exchange unit 27 carries out the processing similar to those of the RTP processing unit 13 and the copyright protection authentication and key exchange unit 17.

At least a part of the authentication and key exchange processing to be carried out by the copyright protection authentication and key exchange unit 27 may be carried out by using IP packets, or by not using IP packets but directly applying the authentication and key exchange protocol to the Ethernet frames. The transmission device 2 of FIG. 2 and the reception device 3 of FIG. 3 are configurations for the case in which data to be used by the authentication and key exchange protocol are directly loaded on the Ethernet frames (or 802.11 frames).

The data format of data to be exchange by the transmission device 2 and the reception device 3 in this embodiment is as shown in FIG. 4. A data link frame is generated by attaching a datalink header d3 to a UDP/IP packet in which a transport layer header d2 is attached to a payload d1 that represents the data body. Namely, the AV data is encapsulated into the UDP/IP packet first, and then the UDP/IP packet is encapsulated into a datalink frame. Also, a physical layer header d4 is attached to the datalink frame.

Note that the frame format for the datalink layer can be that of the Ethernet frame or the 802.11 frame. In the case of the 802.11 frame, the frame format contains the control data to be used only on the radio network 1 such as FC field and Dur/ID field in the IEEE 802.11 radio LAN, for example, but the existence of such control data is ignored in FIG. 4 for the sake of simplicity.

Also, the protocol of the transport layer can be UDP (User Datagram Protocol) or TCP (Transmission Control Protocol), and the protocol of the network layer can be IP (Internet Protocol). In the case where the home network 1 is the radio network 1, a radio layer frame is generated by further attaching a radio layer header to the Ethernet frame, and this radio layer frame is transmitted from the transmission device 2.

In FIG. 4, the existence of trailers is ignored for the sake of simplicity. The radio layer header contains the control data to be used only on the radio network 1 such as FC field and Dur/ID field in the IEEE 802.11 radio LAN, for example.

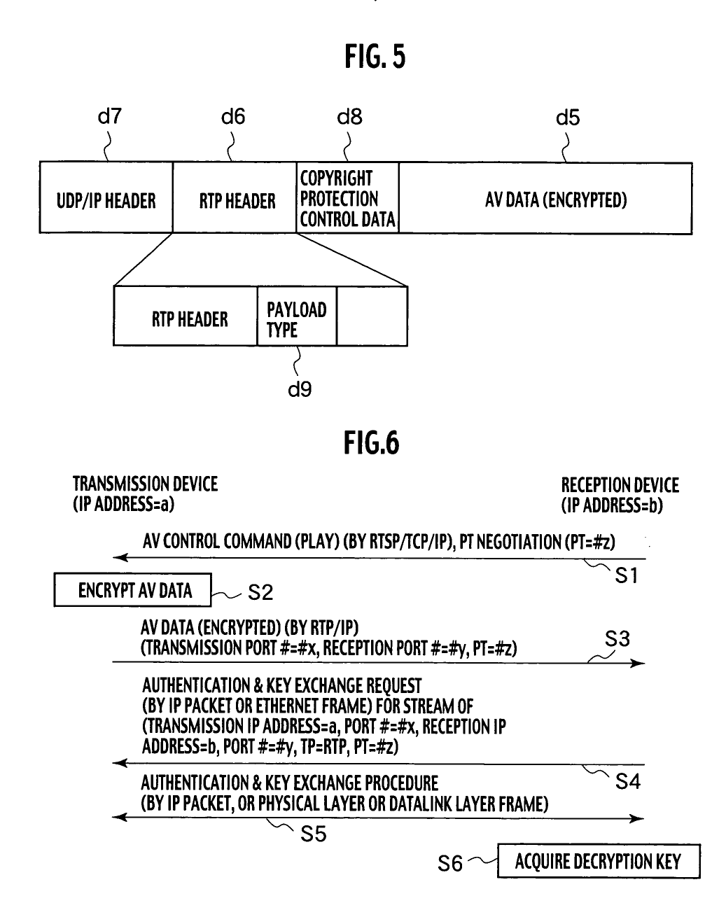

In this embodiment, the AV data that require the copyright protection are transmitted in an encrypted form. The encryption is applied to the payload portion of the UDP/IP packet of FIG. 4. A more detailed data format of this payload portion is as shown in FIG. 5. An RTP (Real-time Transport Protocol) header d6 of the RTP which is a transfer protocol for the AV data transfer standardized by the IETF and a UDP/IP header d7 are attached to a payload d5 in which the AV data are encrypted, and a copyright protection control data d8 is further attached between the RTP header d6 and the payload d5. This copyright protection control data d8 comprise a copy control information (CCI), a bit for notifying a timing of a change of the value of the key for encryption applied to the AV data, etc. The copyright protection control data d8 may be contained in the RTP header d6. Also a part of the copyright protection control data d8 may be encrypted along with the AV data. For further details of the RTP, see “http://www.ietf.org/rfc/rfc1889.txt”.

In the RTP header d6, a payload type d9 is defined. In this embodiment, a dynamic payload type value (#z) is used as a value of the payload type d9 in the RTP header d6. Here, using the dynamic payload type value implies that a negotiation is carried out in advance for each communication such that a value of the payload type to be used is negotiated and determined dynamically, rather than using an allocated value of the payload type which is determined in advance for each encoding scheme. The negotiation is carried out by the AV control units 18 and 28 of FIG. 2 and FIG. 3.

This measure is taken because the payload is encrypted so that data different from the conventional RTP format will be entered into the payload and the copyright protection control data d8 is inserted between the RTP header and the payload, unlike the conventional RTP. Namely, the conventional RTP format and the format in which the copyright protection control data d8 is inserted are different, so that the reception device 3 that received the RTP packet needs to identify which format the RTP packet has, or whether the received packet is the encrypted data that require the decryption or not.

FIG. 6 shows a processing procedure of the first embodiment for the AV data encryption and transmission processing to be carried out by the transmission device 2 and the reception device 3. In the following, the encryption and transmission processing of the first embodiment will be described in detail with reference to FIG. 6. Here, the mechanism for the copyright protection is assumed to be DTCP (Digital Transmission Content Protection) as an example. For further details of the DTCP, see “http://www.dtcp.com”.

First, the reception device 3 requests the transmission of the AV data to the transmission device 2 (step S1). Here, the exchange of the command (protocol) on the TCP/IP is carried out by using RTSP (Real Time Streaming Protocol (see RFC 2326) which is the protocol for the remote control of the AV streaming function defined by the IETF. Note that, besides RTSP, it is also possible to carry out the similar control by using the AV/C of the IEEE 1394, the UPnP (Universal Plug and Play) protocol, etc.

In the RTSP, the negotiation is carried out for (1) the encoding scheme used for the AV streaming transmission and various attributes and parameters such as its bit rate, etc., (2) a type of the transport protocol (TP) to be used (which is RTP/UDP in this embodiment). (3) a value of the payload type to be used by the RTP (for which a value of the dynamic payload type is used in this embodiment), (4) a value of the TCP or UDP port number by which the communication is to be carried out (TCP is used in this embodiment, but it is also possible to use UDP), and (5) the definition of the streaming operations (such as play, rewind, stop), etc.

When the agreement is reached for the above described (1) to (5) between the transmission device 2 and the reception device 3, the transmission device 2 encrypts the AV data (step S2), and then starts the transmission of the AV stream that contains the encrypted AV data, by using the connection agreed by the above described RTSP (which is transmission IP address=a, transmission port number=#x, reception IP address=b, reception port number=#y in this embodiment), the transfer protocol=RTP, and the agreed dynamic payload type (PT) value (=#z) (step S3).

The AV stream transmitted at the step S3 has the data format as shown in FIG. 5. Here, suppose that the reception device 3 that received this AV stream discovers that the encryption is applied to the received AV data according to the copyright protection control data d8 in the AV stream, for example. In this case, the reception device 3 requests the authentication and key exchange procedure to the transmission device 2 (step S4), and carries out the authentication and key exchange processing with the transmission device 2 (step S5). When the authentication and key exchange processing succeeds, the reception device 3 acquires the decryption key (step S6).

The configuration of the copyright protection control data d8 may be different depending on the protocol of the transport layer of the AV stream to be transferred. For example, in the case where the transport layer protocol is TCP, a Length field for indicating a size of the encrypted AV data may be defined. Of course, it is also possible to define the Length field even in the case where the transport layer protocol is UDP.

The authentication and key exchange request and the authentication and key exchange processing may be carried out on TCP/IP packets, or data for the authentication and key exchange may be directly loaded on radio layer frames or Ethernet frames. Also, this authentication and key exchange procedure should be done within the home network 1, so that in the case of carrying it out on TCP/IP packets, it is preferable to provide some limitation such as carrying out communication in a state where a value of TTL (Time To Live) is set to a value for which packets can only reach within the home network 1 (a value “1”, for example).

The authentication and key exchange is carried out for the AV stream to be transferred by the specific RTP stream. For this reason, there are cases where it is necessary to carry out the negotiation regarding for which AV stream this authentication and key exchange concerns, as a pre-requisite for carrying out the authentication and key exchange.

For example, there can be a case where the reception device 3 recognizes that the received AV stream is encrypted, and makes an inquiry to the transmission device 2 that indicates “the authentication and key exchange for this AV stream is desired”. There can also be a case where the transmission device 2 judges that “this AV stream is to be transmitted to the reception device 3 in an encrypted form, so that there is a need to notify this fact to the reception device 3 either in advance or at a time of the AV stream transfer such that the reception device 3 will trigger the authentication and key exchange”, and makes a notification to the reception device 3 which indicates “this AV stream is transmitted in an encrypted form so that the authentication and key exchange procedure for this AV stream should be carried out with the transmission device 2”.

Of course, instead of carrying out the authentication and key exchange separately for each AV stream, it is possible to carry out the authentication and key exchange for validating all the RTP streams that are exchanged between the transmission device 2 and the reception device 3 first, such that thereafter the encryption of the AV data can be carried out according to the conditions determined by the above described authentication and key exchange procedure, for all the RTP streams that are exchanged between the transmission device 2 and the reception device 3.

Also, an agreement that the copyright protection is applied for the specific payload type value can be made in advance between the transmission device 2 and the reception device 3, such that when the RTP stream having the specific payload type value is received, it can be regarded as the RTP stream with the copyright protection applied. Of course, it is also possible to carry out the negotiation regarding the fact that the DTCP copyright protection is applied to the RTP session to be set up, in the RTSP.

FIG. 6 described above shows the processing procedure in the case where the reception device 3 triggers the authentication and key exchange with respect to the transmission device 2. The reception device 3 recognizes the fact that the received AV stream is encrypted by some method. For example, this fact can be recognized in “the case where the desired AV stream cannot be reproduced even when the received AV stream is decoded”, “the case where the copyright protection control data d8 as shown in FIG. 5 is attached to the received AV stream and the fact that this AV stream is encrypted can be recognized by detecting this copyright protection control data”, or “the case where the dynamic payload type value is used as the value of the payload type of the RTP, and the fact that this AV stream is encrypted can be recognized when this value is a value to be used in the case where data are encrypted”.

The reception device 3 that recognized the fact that the received AV stream is encrypted, or there is a possibility for that, transmits the authentication and key exchange request to the transmission device 2. This procedure can be included as a part of the DTCP procedure. In this case, the reception device 3 explicitly indicates that “for which AV stream this authentication and key exchange concerns” by that authentication and key exchange request (or by the subsequent authentication and key exchange procedure packet). In this embodiment, the transfer protocol type (RTP) and the value of the payload type (#z) of the RTP packet are used for this purpose.

It is also possible to explicitly indicate the IP address and the port number of the transmission device 2 and the IP address and the port number of the reception device 3 in that authentication and key exchange request, and it is also possible to use a value of the SSRC field of the RTP (an identification number uniquely assigned to each AV source (see RFC 1889)), or a value of the “flow ID” contained in the IPv6 packet.

The transmission device 2 that received this authentication and key exchange request recognizes the payload type value of a target AV stream of this authentication and key exchange request (or the authentication and key exchange procedure), and continues the authentication and key exchange procedure.

When the authentication and key exchange procedure is finished, the reception device 3 can acquire the decryption key for that encrypted AV stream (or an initial information necessary for the calculation for acquiring the decrypting key), according to the authentication and key exchange result (step S6).

Note that the key Kz to be used for encrypting the contents in this embodiments has a value generated by a function f with inputs given by a key Ka generated by the authentication and key exchange processing between the transmission device 2 and the reception device 3, and a key Kb (which will be referred to as a seed value hereafter) formed by a plurality of bits (64 bits, for example) which are randomly set for each session by the transmission device 2 after the authentication and key exchange succeeds. Namely, the key Kz is obtained by the following formula.

Kz=f(Ka, Kb)

Also, here it is assumed that the seed value Kb is initialized (set randomly again) whenever the transmission device 2 sets another value for the key Ka. It is also assumed that the transmission device constantly updates the value of Kb at constant interval during the AV data transmission.

Conventionally, a field for inserting a lower one bit of Kb is defined in the copyright protection control data d8, and the transmission device 2 transmits by inserting the lower one bit of Kb used in calculating Kz which is the key for encrypting the contents into this field.

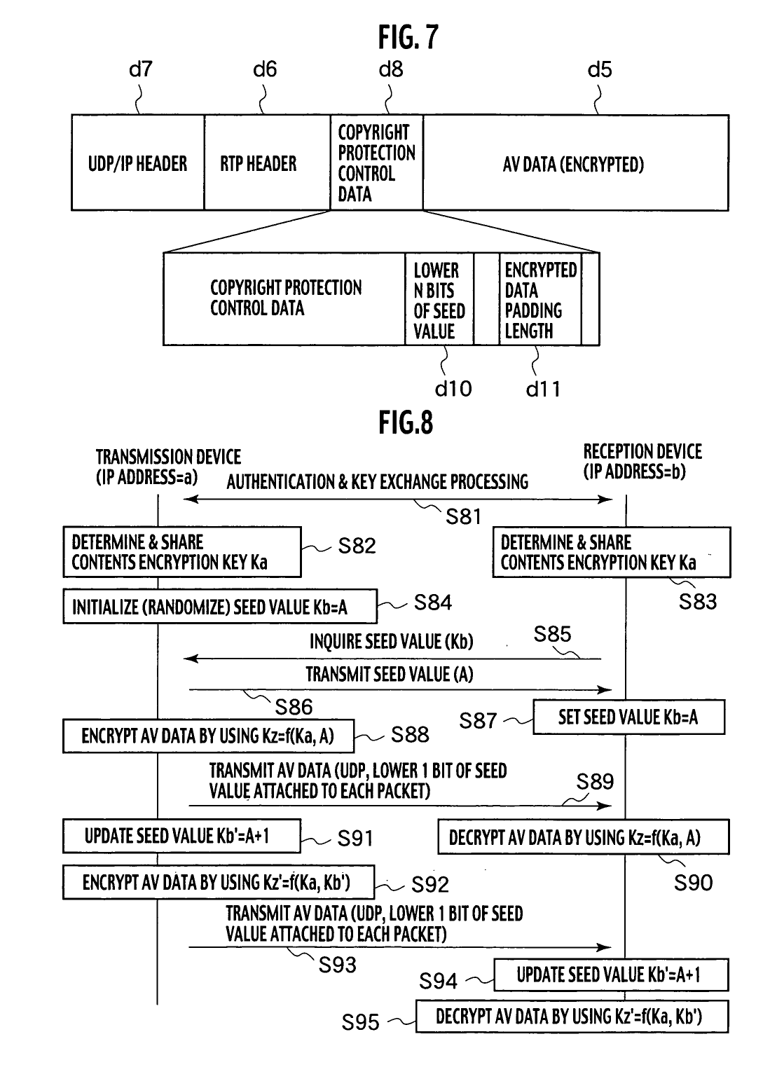

FIG. 7 shows a data format of the copyright protection control data d8. Note that the copyright protection control data d8 may contain lower N bits d10 of the seed value and an encryption data padding length d11.

Depending on the encryption algorithm to be used in encrypting the AV data, there can be cases where the sizes by which the encryption can be applied are limited to units obtained as integer multiples of a fixed length (integer multiples of 8 bytes, for example). In the case of using the algorithm for encrypting the data in units of 8 bytes, for example, the encryption of the data in 14 bytes will require the attaching of padding in 2 bytes to the original data. This encryption data padding length d11 will be used in order to notify the padding in how many bytes is inserted at the reception device side. The actual value can be a value of the bytes of the padding or a data length of the original data before padding, or a coded value that represents these values.

FIG. 8 shows a method for processing Ka, Kb and Kz. First, the transmission device 2 and the reception device 3 carry out the authentication and key exchange processing (step S81). When the authentication and key exchange succeeds, the transmission device 2 and the reception device 3 can share the key Ka (steps S82, S83). As described above, the AV data will be encrypted by using the key Kz generated by the function f with inputs given by this key Ka and the seed value Kb.

Next, the transmission device 2 initializes the seed value Kb (Kb=A) (step S84). The reception device 3 makes an inquiry for the seed value Kb to the transmission device 2 (step S85), and the transmission device 2 transmits the seed value A to the reception device 3 (step S86). The reception device 3 sets the received seed value A (step S87).

The transmission device 2 encrypts the AV data by using Kz=f(Ka, A) (step S88), and transmits the encrypted AV data (step S89). At this point, the encrypted AV data is transmitted by attaching a lower one bit of the current seed value Kb to the copyright protection control data d8 for the AV data.

The reception device calculates the key Kz for decrypting the AV data according to the value of the lower one bit of the seed value Kb contained in the copyright protection control data d8 for the AV data and Ka, and decrypts the AV data (step S90).

Note that each AV data contains only the lower one bit of Kb, so that the reception device 3 cannot calculates Kz from Ka and the lower one bit of Kb alone. For this reason, after the authentication and the key exchange processing, the reception device carries out a processing for inquiring values of all bits of Kb set by the transmission device 2 at the step S85 described above.

In this way, the reception device 3 learns the value of Kb only once at first. Thereafter the reception device 3 can detect the updating of Kb by the transmission device 2 by monitoring a change of the lower one bit of Kb contained in the copyright protection control data d8 for the AV data, and calculate the value of the key for decrypting the contents from the seed value after the update and Ka. Here, what is important is that the lower one bit of Kb defined in the copyright protection control data d8 is used for notifying a timing of a change of the value of Kb.

As described above, the transmission device 2 updates the value of Kb during the AV data transmission (step S91). Note that the updating can be made by a method for updating at constant time interval or a method for updating by a constant value (a value “1” for example) at a constant number of bytes in the AV data to be transmitted. Here, for the sake of simplicity, it is assumed that the seed value is increased by one at a constant number of bytes.

FIG. 8 shows the case where the transmission device 2 updated the value of Kb from A to A+1. In conjunction with the update of Kb, the key Kz to be used in encrypting the contents is re-calculated. More specifically, the key Kz′ is calculated by using the function f from Ka and A+1. The contents are encrypted by using this Kz′ and transmitted (steps S92, S93). Note that the lower one bit of A+1 is inserted into the copyright protection control data d8 for the AV data encrypted by using Kz′.

The reception device 3 that received this AV data can recognize that Kb is changed from A to A+1, from the value of the lower one bit of Kb inserted in the copyright protection control data d8 for the AV data (step S94), and calculates the key Kz′ for decrypting the contents by using the function f from Ka and A+1. In this way, the received AV data can be decrypted correctly (step S95).

Note that, for the messages to be used in inquiring the seed value and responding to it, the IP packets may be used, or message data can be directly loaded on 802.11 frames (or Ethernet frames) without using the IP packets, similarly as the messages used by the authentication and key exchange.

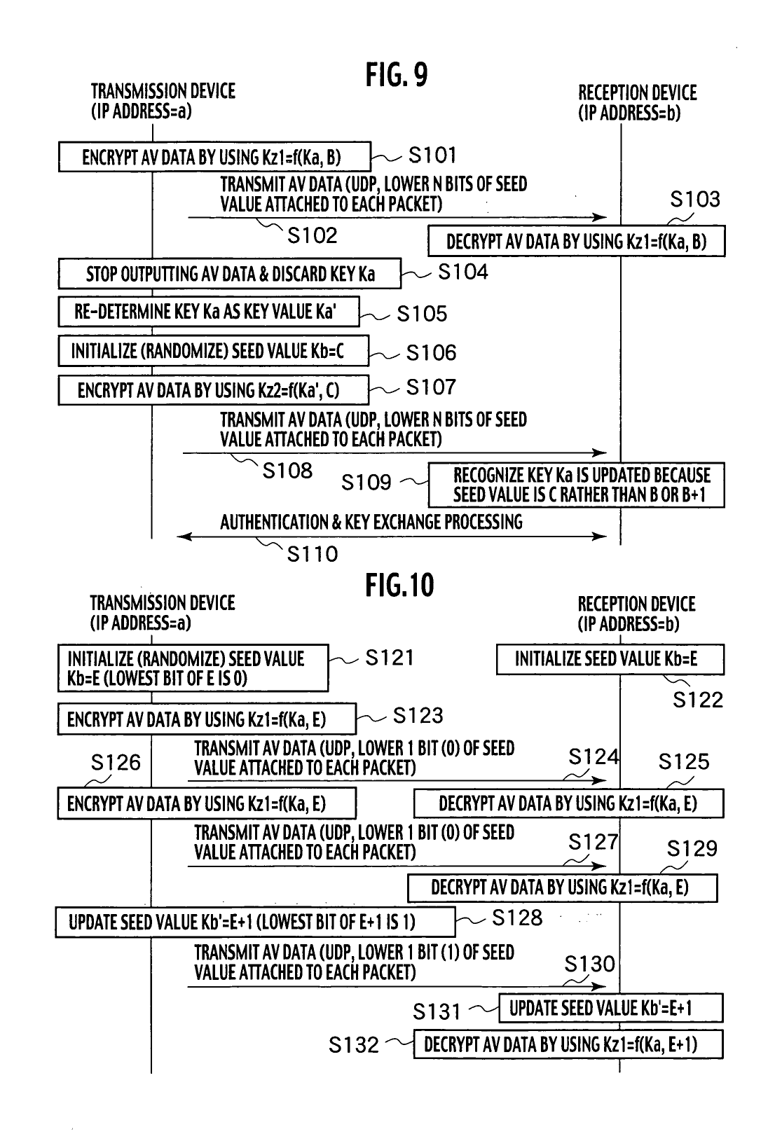

FIG. 9 shows a processing sequence for detecting the contents key update by the transmission device 2. In the following, the effect of setting lower plural bits rather than the lower one bit of the seed value Kb in the copyright protection control data d8, which is one of the features of this embodiment, will be described with reference to FIG. 9. Here, it is assumed that the seed value Kb is updated at constant time interval and the current value is B.

First, the transmission device 2 encrypts the AV data by using the encryption key Kz1=f(Ka, B) (step S101), and transmit it to the reception device 3 (step S102). The reception device 3 decrypts the AV data by using the decryption key Kz1=f(Ka, B) (step S103).

Here, suppose that the transmission device 2 abandons Ka shared with the reception device 3 (step S104) for the reason such as the transmission device 2 stops the output of the AV data or the transmission device 2 is re-activated, and updates it to a new value Ka′ (step S105). At the same time, the seed value is initialized, and set to a value C different from B (step S106).

In the RTP, it is customary to use the connection less type protocol UDP for the lower layer. In the connection-less type protocol, the reception device and the transmission device do not maintain their states, so that even if the transmission device 2 abandons the session, the reception device 3 cannot detect this.

Consequently, in the conventional method, even if the transmission device 2 is re-activated and updates the key value to Ka′, the detection device 3 has no way of knowing that. Also, in the case of using the connection-less type protocol, when the packet is lost on the transmission path between the transmission device and the reception device or the reception device fails to receive the packet, there is no way of knowing this packet loss. However, by setting the lower plural bits of the seed value Kb in the copyright protection control data d8, it becomes possible to detect the change of Ka at the reception device 3 and it becomes possible to detect the occurrence of the packet loss, for the following reason.

First, the way of detecting the change of the seed value will be described. Suppose that the transmission device 2 abandons Ka shared with the reception device 3 and updates it to a new value Ka′. The transmission device 2 obtains the key Kz2 for encrypting the contents by using the updated key Ka′ and the seed value C, encrypts the AV data by using Kz2 and transmits it (steps S107, S108). The reception device 3 that received this AV data recognizes that the lower N bits of the seed value contained in the copyright protection control data d8 are those of C, which are different from those of B that have been received until then or those of B+1 that can be obtained by updating B.

When the bit length of Kb is sufficiently long, a probability for the value (C) randomly set by the initialization and the previously used value (B or B+1) to coincide is low, so that the reception device that received the AV data for which the seed value is different from the expected value B or B+1 can detect that the transmission device 2 has updated the key Ka, during the processing (step S109).

Next, the way of detecting the occurrence of the packet loss on the communication path between the transmission device and the reception device will be described.

FIG. 10 shows an exemplary processing procedure in the case where the lower one bit of the seed value is set in the copyright protection control data d8 for the AV data. The procedure up to a point where the transmission device 2 and the reception device 3 share the seed value is the similar to the procedure up to the step S86 of FIG. 8. Here, it is assumed that the shared seed value is E (step S121). It is also assumed that the lowest bit of E is “0”. The transmission device 2 updates the seed value at constant time interval, according to the rule described above (step S128). Here, it is assumed that the seed value is to be sequentially updated from E to E+1, E+2 and E+3. Namely, the lowest bit of E+1 is “1”, the lowest bit of E+2 is “0”, and the lowest bit of E+3 is “1”.

In the case of setting the lower one bit of the seed value in the copyright protection control data d8 for the AV data, the reception device 3 receives “0” which is the lowest bit of E, for the AV data encrypted by using the seed value E by the transmission device 2, and then sequentially receives “1”, “0” and “1” as the seed value is updated to E+1, E+2 and E+3 by the transmission device 2, and decrypts the received AV data by using the seed value of E+1, E+2 and E+3 (steps S124, S127, S132).

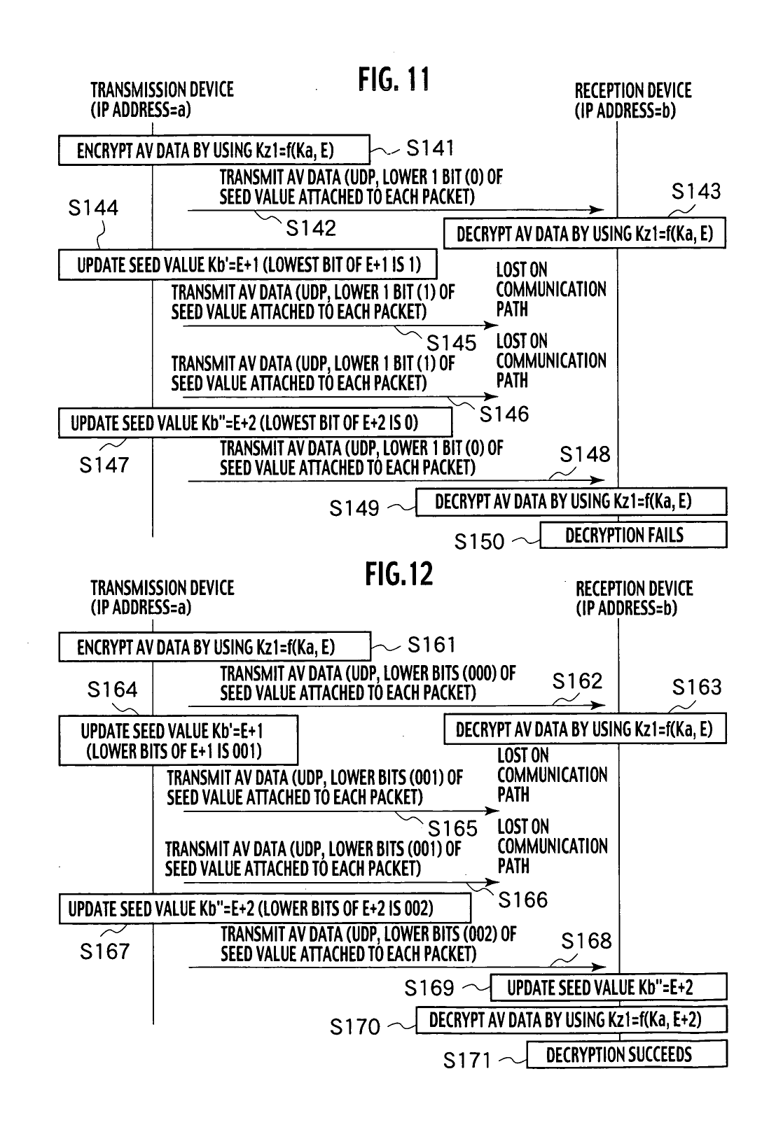

Next, FIG. 11 shows the processing sequence in the case where the packet loss occurs. The procedure while the AV data is transmitted and received by using the seed value E is the same as the procedure of FIG. 12. Here, suppose that the reception device 3 failed to receive all the data for which the seed value is E+1 (steps S145, S146).

In the connection-less type protocol, the re-transmission of the lost data is not carried out, so that the reception device 3 cannot know that it has failed the reception of the data with E+1. Namely, after receiving the lowest bit “0” of the seed value E, the reception device 3 receives the lowest bit “0” of the seed value E+2, so that the update of the seed value is not carried out. For this reason, even though the transmission device 2 is encrypting the AV data by using the seed value E+2, the reception device 3 decrypts the received AV data by using the seed value E so that the AV data cannot be decrypted correctly (step S150).

On the other hand, FIG. 12 shows the processing procedure in the case of setting the lower plural bits of the seed value in the copyright protection control data d8. Here, for the sake of simplicity, the number of lower plural bits of the seed value is set to three. In this case, even if the reception device 3 failed to receive the data encrypted by the seed value E+1, the fact that the seed value has been updated can be detected by checking the value of the seed value contained in the data encrypted by using E+2 (step S169), and the AV data can be decrypted correctly (step S170).

In order to achieve the same effect, it is also possible to set all bits of the seed value in the copyright protection control data or newly define the contents encryption key number. However, compared with the case of transferring all bits, the case of transferring the lower N bits of the seed value can suppress the size of the header so that the AV data can be transferred efficiently.

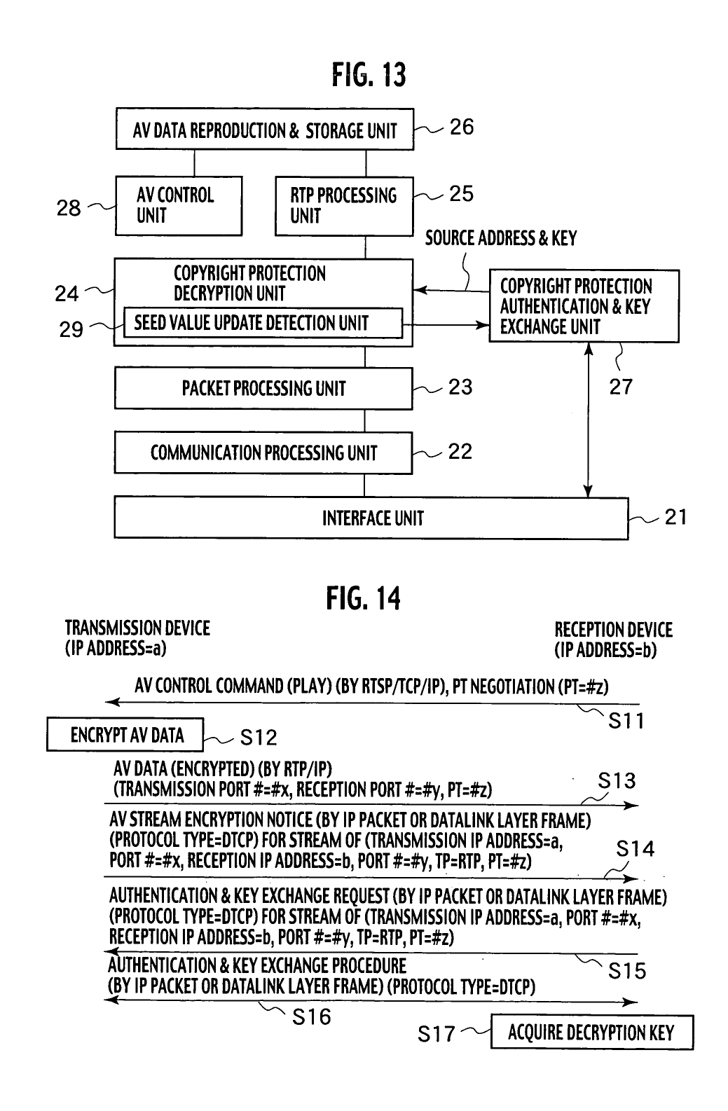

FIG. 13 shows the internal configuration of the reception device 3 in the case of setting the lower plural bits of the seed value Kb in the copyright protection control data d8. The difference from FIG. 3 is that it has a seed value update detection unit 29 which has a function for judging whether the value of the seed value contained in the copyright protection control data d8 for the received AV data is the same as the previously received seed value or a value that can be predicted from that seed value (a value greater than that seed value by one, for example), or not, and notifying the copyright protection authentication and key exchange unit to carry out the authentication and key exchange again if it is not the expected value.

As described, in the first embodiment, the AV stream in which the protocol type (RTP, for example) and the value of the payload type to be used by this protocol are attached to the payload in which the AV data that requires the copyright protection is encrypted is transmitted from the transmission device 2 to the reception device 3, so that the reception device 3 that received this AV stream can easily detect that the AV data is encrypted, and easily identify the data for which the authentication and key exchange is necessary. In this way, it becomes possible to receive and reproduce the AV data easily and quickly, while realizing the copyright protection.

Also, by transmitting only a part of the bits of the seed value to the reception device 3, rather than transmitting the seed value for generating the decryption key as it is to the reception device 3, the amount of data of the AV data can be suppressed, and the security can be improved.

(Second Embodiment)

The second embodiment is directed to the case where the transmission of the encrypted AV data is notified from the transmission device 2 to the reception device 3.

The transmission device 2 and the reception device 3 of the second embodiment have the configurations similar to those of FIG. 2 and FIG. 3, but a part of the AV data encryption and transmission processing is different from the first embodiment.

FIG. 14 shows the processing procedure for the AV data encryption and transmission processing to be carried out by the transmission device 2 and the reception device 3 of the second embodiment. In the second embodiment, after the transmission device 2 transmitted the AV stream containing the encrypted AV data to the reception device 3 (step S13), the transmission device 2 transmits an AV stream encryption notice to the reception device 3 in order to notify that the AV data is encrypted (step S14). This notice notifies to the reception device 3 that the AV stream (payload type=#z) transmitted by the transmission device 2 is encrypted according to the protocol such as DTCP, and there is a need to carry out the authentication and key exchange with the transmission device 2 in order for the reception device 3 to be able to decrypt this AV data. This notice may be made by using an IP packet, a radio layer packet, or an Ethernet frame. Alternatively, it is also possible to include a message of “encrypted contents is transmitted” in a response message of HTTP as a contents designation response message, or it is also possible to transmit it in a format that extends SDP (Session Description Protocol)(see RFC 2327).

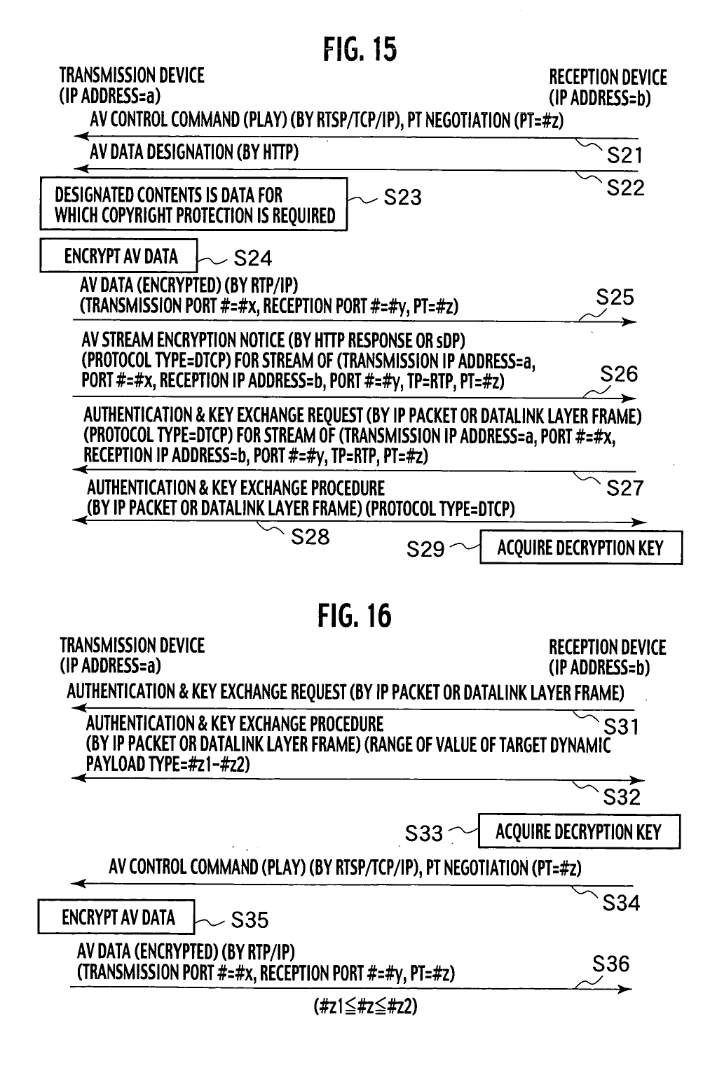

FIG. 15 shows the processing procedure in the case where the reception device 3 designates a desired AV data to the transmission device 2, and the fact that this AV data is encrypted is notified as a response to that designation.

First, the reception device transmits the AV control command to the transmission device 2 (step S21), and then designates the AV data contents (step S22). This contents designation can be made by using a known method such as HTTP, for example.

The transmission device 2 recognizes that it is the designated contents is the contents that requires the copyright protection from the attached information of the contents (step S23), encrypts and transmits the AV data (steps S24, S25), and then transmits the AV stream encryption notice by using a response message of HTTP or SDP (step S26). In this way, the reception device 2 can learn that there is a need to carry out the authentication and key exchange with the transmission device 2.

The reception device 3 that recognized the fact that the received AV stream (stream with the payload type=#z) is encrypted transmits the authentication and key exchange request to the transmission device 2 (step S27), and the authentication and key exchange processing is carried out between the transmission device 2 and the reception device 3 (step S28).

Note that, in FIG. 14 and FIG. 15, the exemplary case of notifying the specific value (#z) as the value of the payload type has been shown, but it is also possible to notify a range formed by two or more types of the payload type for which the copyright protection is applied (values in a range of #z1 to #z2, for example).

As described, in the second embodiment, the fact that the AV data in the AV stream is encrypted is notified from the transmission device 2 to the reception device 3, so that there is no need for the reception device 3 itself to check whether the AV data in the received AV stream is encrypted or not. Consequently, the processing of the reception device 3 can be reduced, and the time required until the authentication and key exchange processing is completed can be shortened.

(Third Embodiment)

The third embodiment is directed to the case where the authentication and key exchange for the purpose of the copyright protection is carried out before transmitting the AV data.

The transmission device 2 and the reception device 3 of the third embodiment have the configurations similar to those of FIG. 2 and FIG. 3, but a part of the AV data encryption and transmission processing is different from the first and second embodiments.

FIG. 16 shows the processing procedure for the AV data encryption and transmission processing to be carried out by the transmission device 2 and the reception device 3 of the third embodiment. First, the reception device 3 requests the authentication and key exchange to the transmission device 2 by using an IP packet or an Ethernet frame (step S31). Then, the authentication and key exchange is carried out between the transmission device 2 and the reception device 3 (step S32), and when the authentication and key exchange succeeds, the reception device 3 acquires the decryption key (step S33).

During this authentication and key exchange, the fact that “when the value of the payload type of the RTP is within a range of #z1 to #z2, the data of that RTP session is encrypted by the DTCP for the purpose of the copyright protection, and the control data of the DTCP is inserted between the RTP header and the RTP payload” is shared between the transmission device 2 and the reception device 3 at a stage of the authentication and key exchange.

Then, the reception device requests the transmission of the AV data to the transmission device (step S34), and in response the transmission device 2 encrypts the AV data (step S35), and transmits an IP packet or an Ethernet frame in a format of FIG. 4 toward the reception device 3 (step S36). In the example of FIG. 16, the encrypted AV data is transmitted by setting the value of the payload type to be within a range of #z1 to #z2.

The reception device 3 can recognize the fact that this AV stream is encrypted by the DTCP by referring to the value of the payload type, and carry out the reproduction of the AV stream after the appropriate decryption procedure.

Besides that, it is also possible to include a target payload type value in the authentication and key exchange procedure, and add a procedure for notifying the fact that a target of some procedure requested by the command (such as that for inquiring the latest value of the key, for example) is the AV stream with the specific payload type.

As described, in the third embodiment, the authentication and key exchange request is made from the reception device 3, and only when the authentication and key exchange succeeds, the AV stream containing the encrypted AV data is transmitted from the transmission device 2 to the reception device 3, so that the wasteful transmission of the AV stream can be eliminated so that the communication efficiency can be improved and the security can be improved.

(Fourth Embodiment)

The fourth embodiment is directed to the case where the transmission device 2 carries out the determination of the encryption frame size for the AV data with the reception device 3, prior to the transmission of the AV data.

The transmission device 2 of the fourth embodiment divides the AV data into a certain constant size, encrypt divided frames and transmit them to the reception device 3. Note that each divided encryption frame may be formed by a single cipher block, or by a cipher block chain (CBC) in which cipher blocks are chained. The encryption frame size indicates a block length in the case of the single cipher block, or a size of a chained blocks in the case of the cipher block chain.

As a method by which the transmission device 2 and the reception device 3 agrees on the encryption frame size for the AV data, there are various available methods including (1) a method to use a size agreed upon in advance between the transmission device 2 and the reception device 3, (2) a method to notify a size from the transmission device 2 to the reception device 3, (3) a method to notify a size from the reception device 3 to the transmission device 2, (4) a method in which methods of (1) to (3) are combined, etc.

In the case of (1), the transmission device 2 encrypts data and the reception device 3 decrypts data, according to the encryption frame size that is prescribed by a document or the like by each vendor.

In the case of (2), the transmission device 2 specifies the encryption frame size to the reception device 3 prior to the transmission of the AV data.

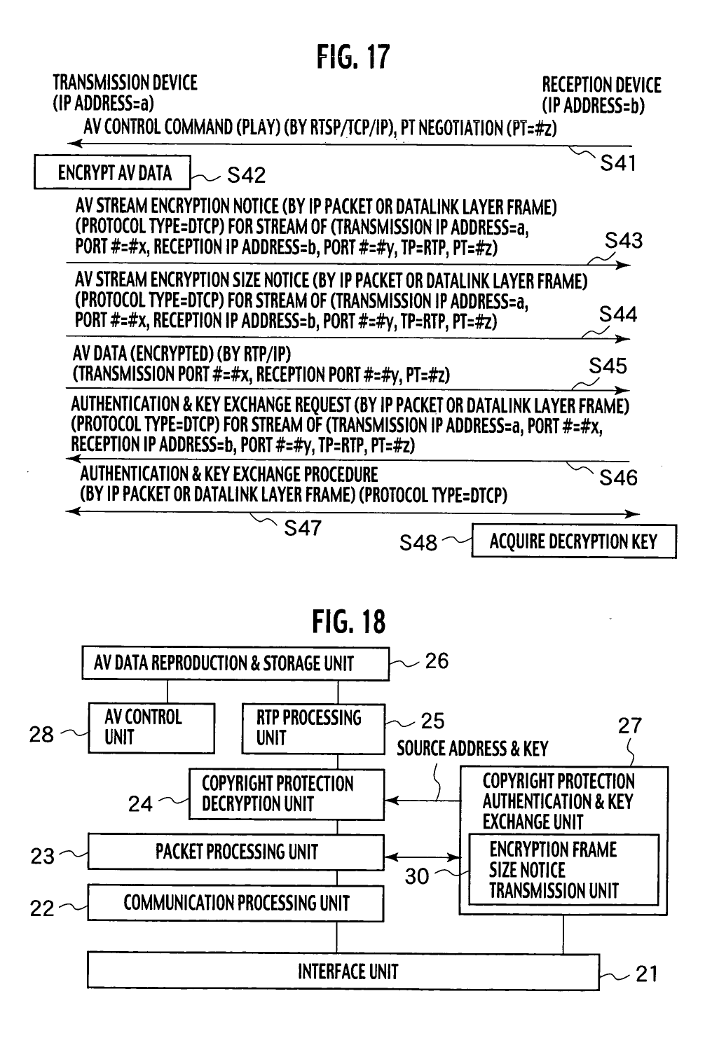

FIG. 17 shows the processing procedure for the AV data encryption and transmission processing to be carried out by the transmission device 2 and the reception device 3 of the fourth embodiment. First, the reception device 3 requests the transmission of the AV data to the transmission device 2 (step S41). In response, the transmission device 2 carries out the encryption of the AV data (step S42).

Next, the transmission device transmits the AV stream encryption notice to the reception device 3 in order to notify the fact that the AV data is encrypted (step S43). The processing up to this point is similar to the second embodiment.

The transmission device 2 transmits an AV stream encryption frame size notice to the reception device 3 in order to notify a size for encrypting the AV stream in constant units. Of course, the AV stream encryption notice and the AV stream encryption frame size notice can be sent by the same packet, and they can be sent as separate packets with an interchanged order.

Note that, in FIG. 17, the exemplary case of including the AV stream encryption frame size notice in a part of the processing procedure of the second embodiment is shown, but this notice is not only applicable to the second embodiment but also to the first embodiment or the third embodiment as long as it takes place before the transmission device 2 transmits the AV data to the reception device 3.

In the case of (3), the encryption frame size that can be processed is notified from the reception device 3 to the transmission device 2.

The configuration of the reception device 3 in the case of using this method is as shown in FIG. 18. In FIG. 18, those constituent elements that are common to the internal configuration of the reception device 3 in the first to third embodiments shown in FIG. 3 are given the same reference numerals, and the difference will be mainly described in the following.

The difference from FIG. 3 is that it has an encryption frame size notice transmission unit 30 inside the copyright protection authentication and key exchange unit 27, and that information generated at the copyright protection authentication and key exchange unit 27 is encapsulated into a packet of the transport layer by the packet processing unit 23.

The encryption frame size notice transmission unit 30 has information regarding the encryption frame size that can be processed when the copyright protection decryption unit 24 decrypts the AV data, and this size is defined as a part of commands of the copyright protection authentication and key exchange unit 27.

Note that the information generated at the copyright protection authentication and key exchange unit 27 is transmitted by encapsulating it in a frame of the radio layer by the interface unit 21 in FIG. 3, but it is transmitted by assembling a TCP/IP packet at the packet processing unit 23 in FIG. 18. Of course, it can also be transmitted by encapsulating it in a frame of the radio layer similarly as in the case of FIG. 3, and it can also be transmitted by encapsulating it in a frame of the datalink layer directly by utilizing the communication processing unit 22.

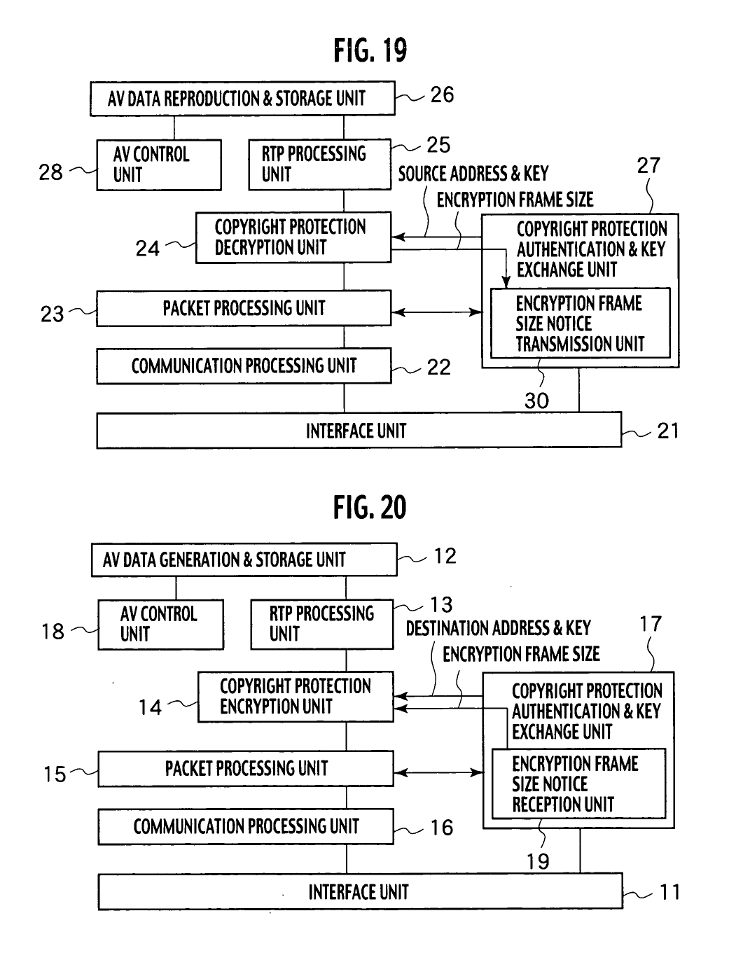

Also, FIG. 18 shows an exemplary case where the encryption frame size notice transmission unit 30 has the information regarding the encryption frame size that can be processed by the copyright protection decryption unit 24, but it is also possible to inquire that information to the copyright protection decryption unit 24 from the encryption frame size notice transmission unit 30 in (a) the case where the copyright protection decryption unit 24 can process the variable encryption frame size, and (b) the case where the information regarding the encryption frame size that can be processed is maintained at the copyright protection decryption unit 24. In such cases, the internal configuration becomes as shown in FIG. 19.

FIG. 20 shows the internal configuration of the transmission device 2 in the case of using the method of (3). In FIG. 20, those constituent elements that are common to the internal configuration of the transmission device 2 in the first to third embodiments shown in FIG. 2 are given the same reference numerals, and the difference will be mainly described in the following.

The difference from FIG. 2 is that it has an encryption frame size notice reception unit 19 inside the copyright protection authentication and key exchange unit 17, and that information generated at the copyright protection authentication and key exchange unit 17 is encapsulated into a packet of the transport layer by the packet processing unit 15.

The encryption frame size notice reception unit 19 has a function for extracting the information regarding the encryption frame size upon receiving a command for notifying the encryption frame size, which is defined as a part of the commands of the copyright protection authentication and key exchange unit 17, and a function for notifying the extracted encryption frame size to the copyright protection encryption unit 14.

The copyright protection encryption unit 14 encrypts the AV data according to the encryption frame size specified from the reception device 3.

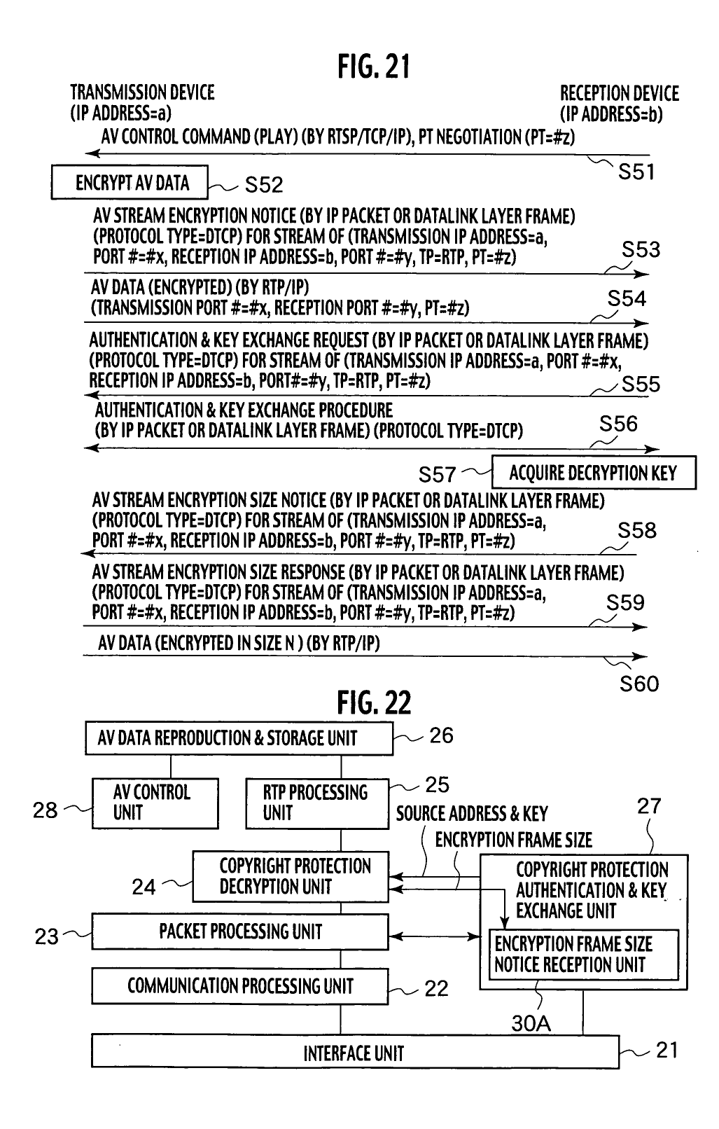

FIG. 21 shows the processing procedure of the method for specifying the encryption frame size in this case. The procedure up to the authentication and the key exchange procedure is similar to that of the second embodiment. When the authentication and key exchange succeeds and the key to be used for decrypting the contents is shared by the transmission device 2 and the reception device 3, the reception device 3 makes the AV stream encryption frame size notice to the transmission device 2. The transmission device 2 encrypts the AV data according to the notified size, and transmit it to the reception device 3.

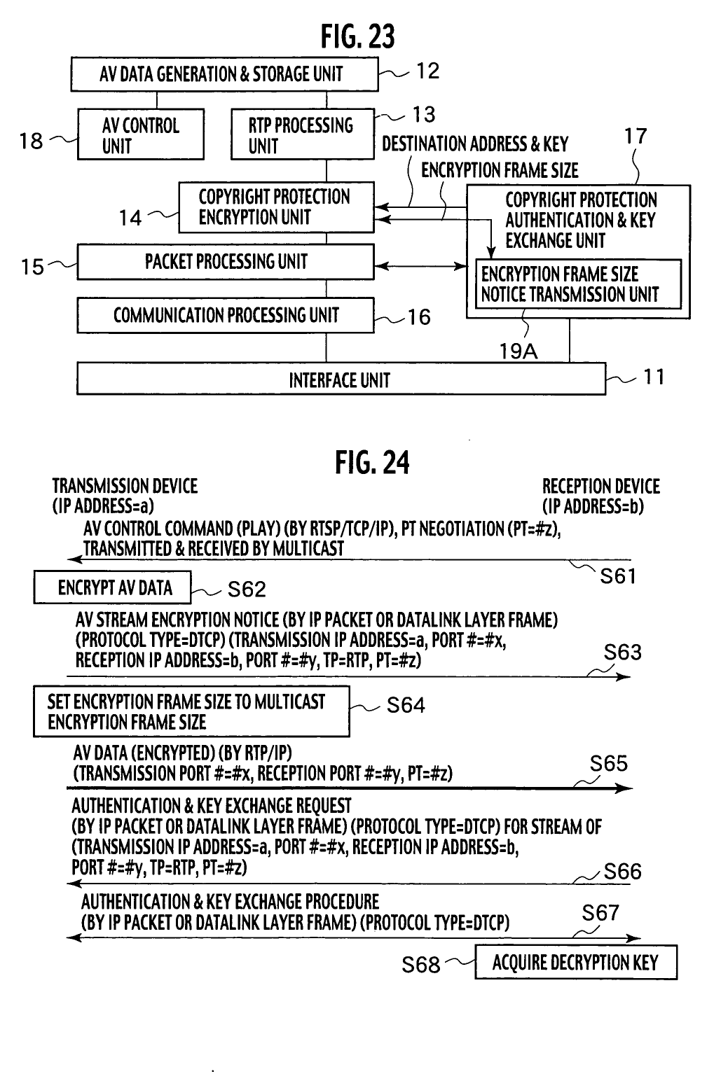

Note that the transmission device 2 may have a function for transmitting a message for specifying the encryption frame size to the reception device 3 in the case where the size that cannot be processed by the copyright protection encryption unit 14 of the transmission device 2 is notified from the reception device 3. In such a case, the internal configurations of the transmission device 2 and the reception device 3 become as shown in FIG. 22 and FIG. 23, respectively. The case where the transmission device 2 cannot process the value of the notified size includes the case where the transmission device 2 does not have a function for encrypting the AV data in the specified size, and the case where the transmission device 2 is already carrying out the transmission of the AV data by the multicast so that the encryption frame size cannot be changed in a middle.

In the case of the multicast communication, once the encryption frame size is determined by the transmission device and the first reception device, even if the second or subsequent reception device joins the multicast communication in a middle and makes the request for specifying the encryption frame size, the size cannot be changed in a middle of the communication. In this case, the encryption frame size (a value of the encryption frame size currently used in the case of the multicast communication) will be specified from the transmission device 2 to the reception device 3.

Note that, in the case of the multicast communication, it is possible to use the method other than the above described method, such as a method to use the multicast encryption frame size that is agreed in advance between the transmission device 2 and the reception device 3, a method to use the multicast encryption frame size that is agreed in advance by negotiation between the transmission device 2 and the reception device 3, which is the method of (1) or a combination of (1) and (2) or (3).

FIG. 24 shows the processing procedure for encrypting the AV data in the multicast encryption frame size that is agreed in advance between the transmission device 2 and the reception device 3 in the case of the multicast communication. In the case where the transmission device 2 transmits the AV data by the multicast, the transmission device 2 encrypts the AV data according to the prescribed multicast encryption frame size and transmits it. The reception device 3 decrypts the AV data received by the multicast according to the prescribed multicast encryption frame size.

The encryption frame size is set differently in the case of the multicast communication and the case of the communication other than the multicast communication. In this way, there is no need to change the encryption frame size in a middle of the communication with respect to the reception device 3 that has joined additionally while the transmission device 2 is transmitting the AV data, and it is possible to prevent the development of the reception device 3 that cannot receive the AV data. Of course, it is also possible to use a method in which a plurality of encryption frame sizes dedicated to the multicast are defined in advance, and one of them is selected by the transmission device 2 and the reception device 3 by the negotiation similar to that of (2) or (3).

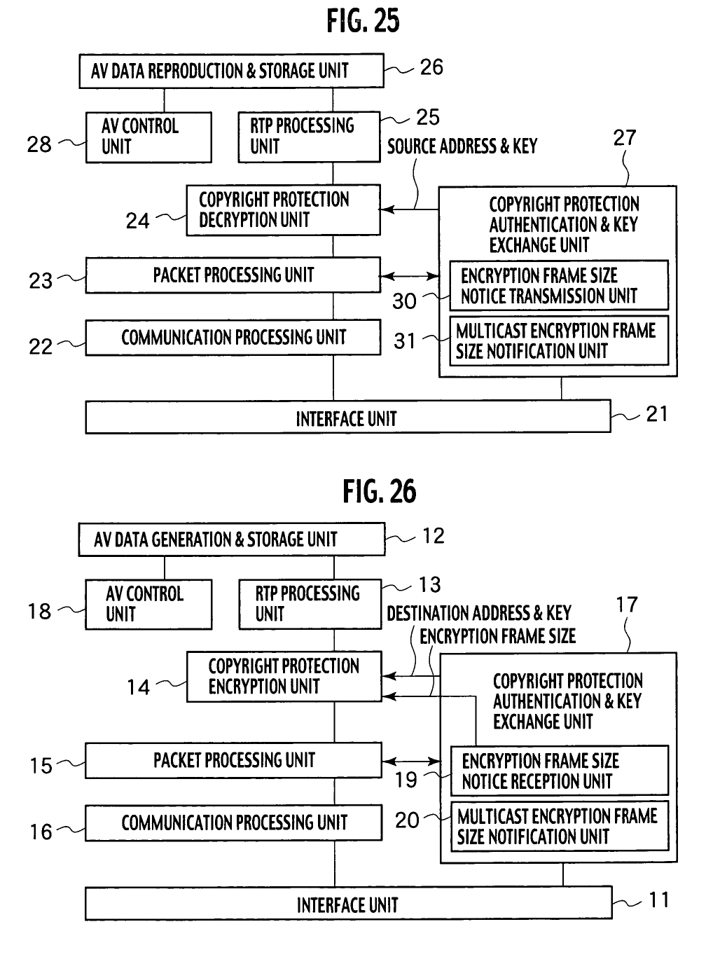

The internal configuration of the reception device 3 in the case of using the method in which the multicast encryption frame size is defined becomes as shown in FIG. 25. The difference from FIG. 18 is that it has a multicast encryption frame size notification unit 31. The multicast encryption frame size notification unit 31 has a function for notifying the multicast encryption frame size to the copyright protection decryption unit 24 when the AV data is received by the multicast. The copyright protection decryption unit 24 decrypts the AV data received from the transmission device 2 according to the encryption frame size notified from the multicast encryption frame size notification unit 31.

The internal configuration of the transmission device 2 in the case of using the method in which the multicast encryption frame size is defined becomes as shown in FIG. 26. The difference from FIG. 20 is that it has a multicast encryption frame size notification unit 20. The multicast encryption frame size notification unit 20 has a function for notifying the multicast encryption frame size to the copyright protection encryption unit 14 when the AV data is to be transmitted by the multicast. The copyright protection decryption unit 14 encrypts the AV data according to the encryption frame size notified from the multicast encryption frame size notification unit 20.

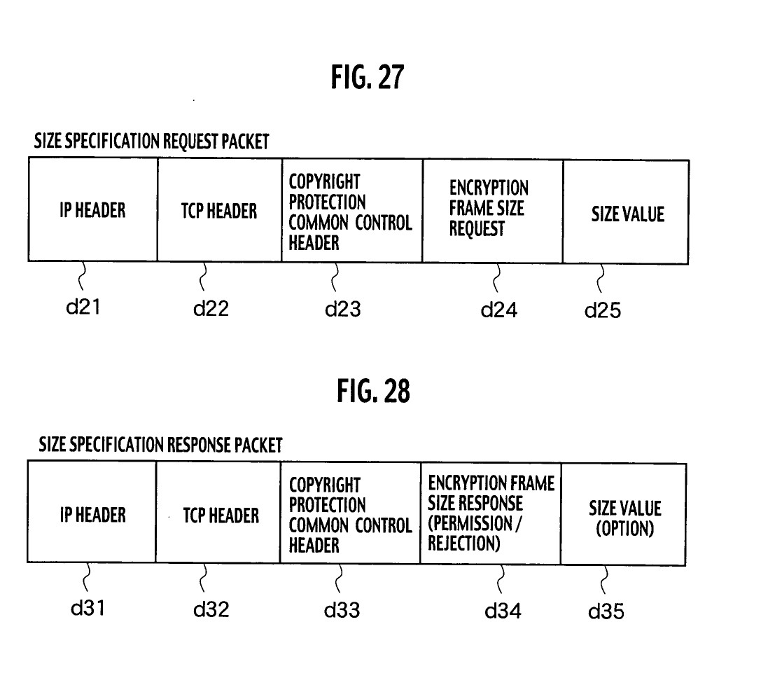

FIG. 27 and FIG. 28 show exemplary data formats to be used for the negotiation of the encryption frame size. The size specification request packet of FIG. 27 is used when the reception device 3 specifies the encryption frame size that can be processed to the transmission device 2, and has an IP header d21, a TCP header d22, a copyright protection common control header d23, an encryption frame size request d24, and a size value d25. The size specification response packet of FIG. 28 is used when the transmission device 2 that received the size specification request packet permits or rejects the transmission in the specified size, and has an IP header d31, a TCP header d32, a copyright protection common control header d33, an encryption frame size response d34 and a size value d35. The size value of the size specification response packet is indispensable in the case of the rejection, but it may or may not be included in the case of the permission.

Also, the exemplary case of including the AV stream encryption frame size notice in a part of the processing procedure of the second embodiment is described here, but this notice is not only applicable to the second embodiment but also to the first embodiment or the third embodiment as long as it takes place before the reception device 3 receives the AV data from the transmission device 2 in a state that can be decrypted. Here, the state that can be decrypted implies a state in which the authentication and key exchange has succeeded between the transmission device 2 and the reception device 3 so that the received AV stream can be decrypted.

As described, according to the fourth embodiment, the encryption frame size that can be processed is notified from the reception device 3 to the transmission device 2, so that it is possible to implement the encryption processing module that can process the encryption frame size in accordance with the usage of the reception device 3, and the manufacturing cost of the device can be suppressed.

For example, in the case of the portable type audio device, the data size of the AV data is small and the transmission rate is low. For this reason, it is preferable to make the encryption frame size small from a viewpoint of the security. On the other hand, for the wire connected TV or the like that is capable of receiving the high resolution images, the data size of the AV data is large and the transmission rate is high. For this reason, it is preferable to make the encryption frame size large. This is because there is a need to divide the large amount data into small size and apply the encryption/decryption processing in the case where the encryption frame size is small and there is a need to have a high speed processing module for this purpose so that the cost of the device is increased.

Also, the appropriate encryption frame size can be different depending on the lower network layer. For example, suppose that the UDP is used as the transport layer protocol. When the UDP packet with a size exceeding the maximum packet size of the datalink layer is to be transmitted, one UDP packet will be divided into a plurality of datalink frames. The UDP does not have the re-transmission processing mechanism, so that when even one frame among these divided datalink frames is lost, the entire UDP packet will be lost. In this case, if the encryption frame size is determined to be large, when one UDP frame is lost, it would become impossible to decrypt data of that encryption frame size. As such, there are cases where the transmission is carried out by aligning the encryption frame size to the datalink frame size in view of the transfer efficiency.

It is preferable to determine the appropriate encryption frame size at each occasion by carrying out the negotiation processing, because the appropriate encryption frame size can be different depending on the performance of the device, the characteristics of the AV data and the characteristics of the network.

The processing of FIG. 6 to FIG. 8 described above can be realized by hardware or software. In the case of realizing it by software, a program for realizing at least a part of the processing of FIG. 6 to FIG. 8 is stored in a recording medium such as floppy disk or CD-ROM, which can be read out from there and executed by a computer. The recording medium is not necessarily limited to a portable one such as a magnetic disk or an optical disk, and can be a fixed one such as a hard disk device or a memory device.

It is also possible to distribute a program for realizing at least a part of the processing of FIG. 6 to FIG. 8 through communication channels (including those of the radio communications) of the Internet or the like. In addition, this program may be distributed in an encrypted, modulated or compressed state, through the wired channels of the Internet or the like or the radio channels, or this program may be distributed by storing it in a recording medium.

The transmission device 2 and the reception device 3 described in the above embodiments may be realized by hardware or software. In the case of realizing them by software, a program for realizing at least a part of functions of the transmission device 2 and the reception device 3 is stored in a recording medium such as floppy disk or CD-ROM, which can be read out from there and executed by a computer. The recording medium is not necessarily limited to a portable one such as a magnetic disk or an optical disk, and can be a fixed one such as a hard disk device or a memory device.

It is also possible to distribute a program for realizing at least a part of functions of the transmission device 2 and the reception device 3 through communication channels (including those of the radio communications) of the Internet or the like. In addition, this program may be distributed in an encrypted, modulated or compressed state, through the wired channels of the Internet or the like or the radio channels, or this program may be distributed by storing it in a recording medium.

As described above, according to the present invention, the packet containing the negotiated value of the payload type is transmitted and received between the transmission device and the reception device, so that it becomes possible to identify whether the electronic data contained in that packet requires the copyright protection or not, and it becomes possible to transmit and receive the electronic data easily and quickly while realizing the copyright protection.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A transmission device, comprising:
a transmission control unit configured to control a transmission of a packet that requires a copyright protection which contains an encrypted electronic data, a copyright protection control data, and an RTP (Real-time Transport Protocol) header including a value of a dynamic payload type that indicates information regarding a state of the encrypted electronic data;
a negotiation unit configured to carry out a negotiation to determine the value of the dynamic payload type for each communication in advance, with a reception device; and
an authentication and key exchange processing unit configured to carry out an authentication and key exchange processing for purpose of the copyright protection, with the reception device.

2. The transmission device of claim 1, further comprising:
a copyright protection information notification unit configured to transmit information for notifying that the packet requires the copyright protection to the reception device, after transmitting the packet to the reception device.

3. The transmission device of claim 1, further comprising:
an encryption information notification unit configured to notify information for notifying that the packet requires the copyright protection and an encryption frame size of the packet to the reception device, before transmitting the packet to the reception device.

4. The transmission device of claim 1, further comprising:
an encryption frame size reception unit configured to receive an encryption frame size of the packet, transmitted from the reception device; and
an encryption unit configured to encrypt the packet according to the encryption frame size received by the encryption frame size reception unit.

5. The transmission device of claim 1, wherein the value of the dynamic payload type indicates more than one values or an arbitrary value within a prescribed range.

6. The transmission device of claim 1, wherein the copyright protection control data contains at least a part of bits of a seed value used in generating an encryption key for encrypting electronic data.

7. The transmission device of claim 1, further comprising:
a multicast transmission identification unit configured to judge whether the packet is to be transmitted by multicast or not, before transmitting the packet; and
a multicast encryption unit configured to encrypt the packet according to a multicast encryption frame size and transmit the packet, when the packet is to be transmitted by the multicast.

8. A reception device, comprising:
a reception control unit configured to control a reception of a packet containing an encrypted electronic data, a copyright protection control data, and an RTP (Real-time Transport Protocol) header including a value of a dynamic payload type that indicates information regarding a state of the encrypted electronic data;
a negotiation unit configured to carry out a negotiation to determine the value of the dynamic payload type for each communication in advance, with a transmission device; and
an authentication and key exchange processing unit configured to carry out an authentication and key exchange processing for purpose of a copyright protection, with the transmission device.

9. The reception device of claim 8, further comprising:
a copyright protection information reception unit configured to receive information for notifying that the packet requires a copyright protection from the transmission device, after receiving the packet that requires the copyright protection from the transmission device.

10. The reception device of claim 8, further comprising:
an encryption information reception unit configured to receive information for notifying that the packet requires a copyright protection and an encryption frame size of the packet from the transmission device, before receiving the packet that requires the copyright protection from the transmission device.

11. The reception device of claim 8, further comprising:
an encryption frame size transmission unit configured to transmit an encryption frame size of the packet that requires a copyright protection, to the transmission device.
an encryption unit configured to encrypt the packet according to the encryption frame size received by the encryption frame size reception unit.

12. The reception device of claim 8, wherein the value of the dynamic payload type indicates more than one values or an arbitrary value within a prescribed range.

13. The reception device of claim 8, wherein the copyright protection control data contains at least a part of bits of a seed value used in generating an encryption key for encrypting the electronic data.

14. The reception device of claim 13, further comprising a decryption unit configured to decrypt the encrypted electronic data contained in the packet received from the transmission device, by using the seed value.

15. The reception device of claim 14, further comprising:
an update judgement unit configured to judge whether the seed value is updated by the transmission device or not, according to the at least a part of the seed value contained in the copyright protection control data transmitted from the transmission device; and
an authentication and key exchange request unit configured to transmit an authentication and key exchange request to the transmission device when it is judged that the seed value is updated by the transmission device.

16. The reception device of claim 8, further comprising:
a multicast reception identification unit configured to judge whether the packet received from the transmission device is a multicast packet or not; and
a multicast decryption unit configured to decrypt the packet according to a multicast encryption frame size and transmit the packet, when the packet is judged as the the multicast packet.

17. A computer program product for causing a computer to function as a transmission device, the computer program product comprising:
a first computer program code for causing the computer to control a transmission of a packet that requires a copyright protection which contains an encrypted electronic data, a copyright protection control data, and an RTP (Real-time Transport Protocol) header including a value of a dynamic payload type that indicates information regarding a state of the encrypted electronic data;
a second computer program code for causing the computer to carry out a negotiation to determine the value of the dynamic payload type for each communication in advance, with a reception device; and
a third computer program code for causing the computer to carry out an authentication and key exchange processing for purpose of the copyright protection, with the reception device.

18. A computer program product for causing a computer to function as a reception device, the computer program product comprising:
a first computer program code for causing the computer to control a reception of a packet containing an encrypted electronic data, a copyright protection control data, and an RTP (Real-time Transport Protocol) header including a value of a dynamic payload type that indicates information regarding a state of the encrypted electronic data;
a second computer program code for causing the computer to carry out a negotiation to determine the value of the dynamic payload type for each communication in advance, with a transmission device; and
a third computer program code for causing the computer to carry out an authentication and key exchange processing for purpose of a copyright protection, with the transmission device.
